(19) United States
(12) Patent Application Publication
(10) Pub. No.: US 2013/0304488 A1
(43) Pub. Date: Nov. 14, 2013

(54) METHOD TO SUPPORT AN ADVANCED HOME SERVICES COORDINATION PLATFORM

(71) Applicant: NEC EUROPE LIMITED, London (GB)

(72) Inventors: Joao Girao, Ludwigshafen (DE); Brigitta Lange, Vaihingen/Enz (DE); Nils Gruschka, Hemmingstedt (DE); Gines Dolera Tormo, Heidelberg (DE); Felix Gomez Marmol, Heidelberg (DE)

(21) Appl. No.: 13/889,613

(22) Filed: May 8, 2013

Related U.S. Application Data
(60) Provisional application No. 61/644,501, filed on May 9, 2012.

(51) Int. Cl. G06F 19/00

(52) U.S. Cl. CPC G06F 19/3418
USPC 705/2

(57) ABSTRACT

A method coordinating home services is provided, including receiving a request for home services from a customer over a network and forwarding the request from the customer to a home services coordinator over the network. A reputation system assists the home services coordinator to select a service provider based on customer needs, preferences, and a reputation of the service provider. Information sufficient to permit the service provider to select a home delivery provider that can satisfy customer needs is provided to the selected service provider over the network. The selected home delivery provider is provided with access to customer data and with access to a customer physical system over the network, to provide the service. Feedback is requested from the customer after the service has been delivered, and is used in the reputation system to update the customer preferences and the reputation of the service provider.

### CROSS-REFERENCE TO RELATED APPLICATIONS

The present application claims the benefit of U.S. Provisional application 61/644,501, filed May 9, 2012, the entirety of which is incorporated herein by reference.

### FIELD OF THE INVENTION

Embodiments of the invention relate a home services coordination platform that combines data management, distributed access control, and reputation management.

### BACKGROUND

The care provider business today is very diverse and consists of many different players such as ambulance companies, nursing at home, home doctors, construction companies, etc. In this arena, there are entities, such as care coordinators, which aggregate these services through sub-contracting other companies. The patient has a contract/service agreement with the care coordinator, and the care coordinator has separate service agreements with the actual care service providers. Such is the case of the Red Cross in the Heidelberg region, and many other regions.

The care coordinator needs to coordinate actions between patients and care service providers. Currently this is a manual task which is inefficient, costs time, can be unreliable (often, it may not even be known by the care coordinator whether the service was provided), and expensive.

In addition to coordinating between patients and care service providers, the care coordinator often has to manage the access control to the patients' houses. This procedure is often handled by storing the keys to each patient's house in a storage room in a facility operated by the Care Coordinator. To access a patient's home, the care giver has to go to the Care Coordinator facility before arriving at a patient's home to handle an emergency raised by the patient. This costs time, which can be critical in such situations.

Similar problems may arise in other fields in which a central coordinator provides home services through a variety of contracted service providers. Examples of such fields may include emergency services, such as police, fire, and private security, as well as services such as in-home nursing, home delivery, energy management, facility management and home repairs, catering and home food delivery, etc. In all of these fields, problems may arise due to difficulties in coordinating information between the central coordinator and contractor service providers, and due to physical access issues, in which further coordination between the central coordinator and the contract service providers is required to provide the contract service providers with, e.g., physical access to a customer's home, office, or other facilities.

### SUMMARY

Based on the above, embodiments of the invention provide a method of coordinating home services that combines a data management, a reputation system, and an access control systems that provide controlled access to the various entities involved in providing home services to both data and access to physical systems (e.g., electronic locks on the doors of patients or other customers). In the context of a platform for providing home medical care services, for example, use of such a system may mean that home care givers no longer have to stop at the home care provider's office to fetch a key and patient information. Instead, they may access this information via mobile devices at the time needed, saving valuable time. Exchange of information (care documentation and patient records), by distributed access control may help to reduce errors and improve the efficiency and quality in health care treatment and in providing of other home services. Electronic records of care services, and visits allow transparency, control, and auditing, making it easier to verify compliance to regulations and to handle necessary tasks, such as billing. Such a coordination system may also enable dynamic staff schedules, patient-specific or customer-specific care/service plans, and documentation of visit/care notes in the field.

Combining access control and service coordination with a reputation system permits the coordination platform to adjust assignments to service providers and care givers or delivery providers according to their reputation and feedback for better quality of care or service. Additionally, the reputation and feedback system may also be used to provide individually customized or tailored services, since individual customer preferences can be tracked and saved by the reputation system. Such reputation and feedback mechanisms may result in gaining customers.

In some embodiments, a method of coordinating home services is provided. The method includes receiving a request for home services from a customer over a network and forwarding the request from the customer to a home services coordinator over the network. A reputation system is used to assist the home services coordinator to select a service provider based on customer needs, customer preferences, and a reputation of the service provider. Information is provided to the selected service provider over the network sufficient to permit the service provider to select a home delivery provider that can satisfy customer needs. The home delivery provider is provided with access to customer data and with access to a customer physical system over the network. The method also includes requesting feedback from the customer after the service has been delivered, and using the customer feedback in the reputation system to update the customer preferences and the reputation of the service provider.

In some embodiments, providing the home delivery provider with access to customer data and with access to a customer physical system includes providing the home delivery provider with information on the home address of the customer and with access to unlock an electronic lock to allow entry to the customer's home. This physical access may, for example be provided by granting access to an electronic lock, such as a near field communication (NFC) lock to a badge, ID card, mobile device, or other electronic ID carried by the home delivery provider. The home delivery provider can present his or her electronic ID at the NFC-lock. The home system then will check whether this ID is authorized to access the door using the system's distributed access control component.

In some embodiments, the method includes receiving information from the home delivery provider and/or the service provider, and logging information on the provided service for auditing and billing purposes. This information can, for example, be provided by the home delivery provider or service provider using a mobile device, computer, terminal, or other electronic device.

In some embodiments, the method includes limiting data and physical access provided to each of the home services coordinator, the service provider, and the home delivery provider according to access policies. In some embodiments, these access policies may be set by the customer. The access policies may be applied in a hierarchical manner, such that the access policies of the customer are combined with the access policies of the service coordinator, service provider, etc. to determine what information will be available to each entity.

In some embodiments, receiving a request for home services includes receiving an automated request based on readings from sensors, or based on a phone trigger, an emergency call system, and related devices (e.g., an emergency call bracelet or necklace). Any device with Internet access or a messaging system could be used to trigger the request. In some embodiments, receiving a request for home services comprises receiving an automated request based on a schedule.

In some embodiments, the method further includes sending notification over the network to the customer of the home delivery provider that will provide the service. This notification may include a photograph and other information on the home delivery provider, so that the customer expects the arrival of the home delivery provider, and can identify them when they arrive at the customer's home.

In some embodiments, the home services are home medical care. In these embodiments, the service provider may be a care provider selected from at least one of a medical practice, a hospital, a pharmacy, a nursing care provider, a paramedic service provider, a social care provider, and an emergency medical service provider. The home delivery provider may be a care giver selected from a medical doctor, a nurse, a paramedic, and a pharmacist.

In some embodiments, the home services are a home food delivery service. In these embodiments, the service provider may be a food delivery service, and wherein the home delivery provider may be a delivery driver.

In some embodiments, the home services may be at least one of a health care service, a home care service, an in-home nursing service, an early patient release service, a behavior monitoring service, an emergency health service, a lifestyle service, a diet service, a fitness/exercise-related service, a facility management service, a home repair service, a gardening service, a shopping service, a home delivery service, an energy use monitoring and savings service, a catering service, a police service, a fire service, and a security service.

In some embodiments, a home service coordination platform is provided. The home service coordination platform includes one or more servers connected to a network, including a reputation service component and an access control component. Some embodiments may also include an identity management component. The one or more servers are configured to receive a request for home services from a customer over the network and forward the request from the customer to a home services coordinator over the network. The servers are further configured to use the reputation system component to assist the home services coordinator to select a service provider based on customer needs, customer preferences, and a reputation of the service provider, and to provide information to the selected service provider over the network sufficient to permit the service provider to select a home delivery provider that can satisfy customer needs. The servers are further configured to use the access control component to provide the home delivery provider with access to customer data and with access to a customer physical system over the network. The servers are further configured to request feedback from the customer after the service has been delivered, and use the customer feedback in the reputation system component to update the customer preferences and the reputation of the service provider.

In some embodiments, the one or more servers are configured to use the access control component to provide physical access to the home of the customer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following, description, various embodiments of the invention are described with reference to the following drawings, in which:

FIG. 1 shows an overview of the operation of a care coordination system in accordance with an embodiment of the invention;

FIG. 2 illustrates the components and services of a home services or care coordination platform in accordance with an embodiment of the invention;

FIGS. 3A and 3B show two possible structures for providing a home services or care coordination platform in accordance with an embodiment of the invention using a cloud-based software-as-a-service model; and

FIG. 4 shows an overview of a coordination platform for a home food delivery “meals on wheels” service in accordance with an embodiment of the invention.

### DESCRIPTION

Current home service coordination systems are manual and cumbersome. For example, in the field of emergency medical services, when an emergency call is raised, the care givers generally must go to a facility or office operated by the Care Coordinator to get a key of the patient's house. That makes the management and handling of emergencies an inefficient process. Additionally, the key to each patient's home is stored in the Care Coordinator's office, which makes the management more complicated.

Additionally, conventional home care service coordination systems typically provide little or no exchange of information or update on status across different home care provider domains. Thus, the exchange and secure access to patients' health and care records enables better quality and more efficient care.

In accordance with embodiments of the invention, a home service coordination system is provided that makes the process lighter and more efficient. According to embodiments of the invention, a home service provider, such as a care giver, can go directly to a client or patient's house, since distributed access control may be used to provide physical access to the home. Additionally, the home service provider can obtain information about the client or patient, and the client or patient can be provided with information about the person who is going to attend her and/or provide home service. Furthermore, the selection of the home service provider can be done according to the user's preferences, taking also into account the reputation of each home service provider.

Regarding access control, many examples of distributed mechanism to enforce access control policies can be found in the literature. However, they are generally related to accessing information or data. Physical access is generally managed locally, where actors involved are known beforehand, and local policies can be directly established. In other words, in this environment, a system administrator is in charge of managing these policies, granting or denying access to specific individuals during a specific periods of time. According to embodiments of the invention, the physical access is instead managed in a distributed way. This permits, for example, a care giver to access a patient's house just when an emergency occurs, although the patient does not necessarily know the identity of the care giver beforehand.

While the examples below will most often be discussed in the context of providing home medical care, particularly on an emergency basis, it will be understood that similar systems and methods could be applied to a wide range of home service or home care scenarios. For example, similar systems and methods could be applied to fields such as emergency services, such as police, fire, and private security, as well as services such as in-home nursing, home delivery, energy management, facility management and home repairs, catering and home food delivery, etc.

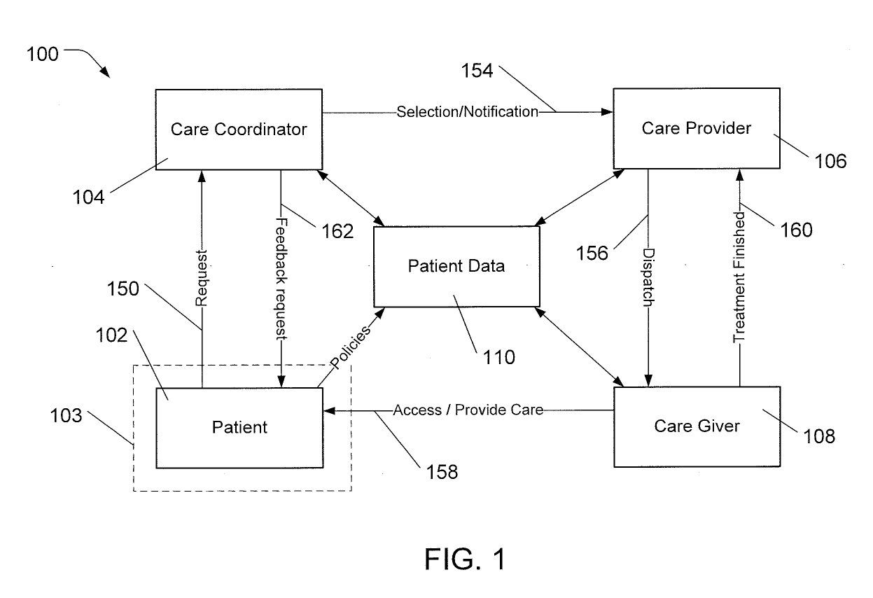

Referring now to FIG. 1, an overview of the operation of a care coordination system 100 in accordance with an embodiment of the invention is described. The system involves a number of entities, including a patient 102, who is generally located in his or her home 103. The patient 102 may be, for example, a person who requires home care and uses or depends on ambient assisted living (AAL) applications in his/her home environment (e.g., an elderly person). The patient 102 subscribes to an emergency medical service offered through a care coordinator 104.

The care coordinator 104 provides and maintains a home emergency call/telemonitoring/telecare infrastructure. Generally, the care coordinator 104 has a call center and coordinates help and home care services (e.g., medical doctors, emergency vehicles, nursing services, etc.). The care coordinator 104 maintains relationships with numerous care providers 106.

The care providers 106 provide home care services in the geographical area of the patient 102 (but do not themselves need to be located in the geographical area of the patient 102), and coordinate mobile care givers. In the context of providing medical care, the care providers may include entities such as hospitals, medical practices, pharmacies, nursing care providers, physiotherapy providers, and so on, providing home care, social care, nursing services, physiotherapy, and home delivery of pharmaceuticals. The care providers 106 maintain relationships with numerous mobile/home care givers 108.

The mobile care givers are prepared to provide care in the home of the patient 102. The mobile care givers may be, e.g. individual doctors, nurses, paramedics, physiotherapists, etc. who provide home care services at the patient's home, and have mobile devices to communicate with the coordinator.

Patient data 110 is also important in the system according to various embodiments of the invention. Patient data 110 is handled in a distributed manner in the system, so that the patient 102 ultimately controls the rules for access to the data, and so that each of the other entities—the care coordinator 104, the care providers 106, and the home care givers 108 each receive the information that they need to provide their respective services. It should be understood that although the patient data 110 is shown in FIG. 1 as a single item, in fact, the patient data 110 may be distributed, and may be stored in a variety of places. Additionally, it will be understood that in some embodiments there may be access rules that are not controlled by the patient, such as rules that provide access and exchange of patient data for legal or other requirements. For example, in case of an emergency, an emergency doctor may be permitted to access relevant patient data stored and controlled by the care coordinator. Of course, all of the various stake holders, including the patient 102, care coordinator 104, care providers 106, and care giver 108 can access or exchange a variety of data other than the patient data 110, and/or not necessarily governed by the patient 102, such as care documentation for billing, accounting, and/or insurance purposes.

FIG. 1 also shows communications in an example scenario for use of the system 100, in accordance with an embodiment of the invention. To start the scenario, a patient 102 has an emergency or a scheduled house call. At 150, the care coordinator 104 is alerted that a service is required by the patient 102. This alert can be based on sensors in the home 103 of the patient 102, on pattern recognition, on an explicit trigger by the patient (e.g., the patient presses a medical panic or emergency button), or on a scheduled event (e.g., as part of a treatment).

The care coordinator 104 selects a care provider 106 based on the needs of the patient. This involves determining both the type or types of care provider that is to be selected (e.g., nurse providers), and the specific provider or providers of that type that will provide the service. This selection may also be made using the reputation management capabilities of the system. This permits a care provider 106 to be selected based in part on the previous patient experience with the available care providers 106. The final selection can be made automatically based on the previous experience and the scoring of the care providers 106 by the patient 102. Alternatively, the selection of the care provider 106 may be made manually by the care coordinator 104, using, e.g., scores that rate different care providers 106 of the type needed by the patient 102. Once a care provider 106 is selected, at 154, the care coordinator 104 informs the selected care provider 106 that a new call exists.

At 156, the care provider allocates one or more care givers 108, such as nurses, doctors, drivers, etc., and dispatches them. It is assumed in this scenario that the selected care givers 108 are already authenticated with the care coordination platform through the care provider 106. At 158, the care givers 108 are given access to all required systems through the care provider 106, the care coordinator 104, and/or the patient 102. These systems may include access to data, such as patient records held by the care coordinator 104 or by other institutions, and access to physical systems, such as access to the home 103 of the patient 102, through, e.g., a near-field communication (NFC) based door lock that can be unlocked using a care giver's ID card, badge, mobile device, or other electronic or RFID-based ID. Access to these systems can be appropriately logged, for security and for billing purposes. Additionally, as will be discussed below, the care givers 108 will no longer have access to the door after they are finished providing the required care to the patient 102.

In accordance with some embodiments, when access to a system is required, the request is first made to the care coordinator 104, who will identify the care provider 106 and combine its decision with respect to access with the decision response from the care provider 106. When receiving the policy decision request, the care provider 106 will identify the subject (e.g., the care giver 108) and confirm the access permission with its policies.

Additionally, in some embodiments, once the care givers 108 are allocated by the care provider 106, the patient 102 will receive a message from the system 100 informing him or her of the care givers 108 that have been assigned, and of their expected arrival. In some of these embodiments, the message may include, e.g., photographs of the care givers 108, so they can be recognized by the patient 102 on their arrival.

At 160, once the service has been provided, the care givers 108 will signal that the treatment is finished, for example using their mobile devices or other electronic devices. The care givers 108 will lose all access to the systems relates to the treatment, including, for example, physical access (e.g., to the patient's home) and data access (e.g., to the patient's data). Details on the treatment (including, e.g., a time stamp) will be recorded by the system in order to allow later auditing, which may be required in some jurisdictions, and for possible use in billing for the treatments and services that were provided.

At 162, the patient 102 will receive a feedback/quality control request to rate the treatment that was just received, for use in the reputation management system. This feedback could be given, for example, by filling in a physical or an electronic form (e.g., via the Internet or Web), verbally, or in natural language. The feedback is then added to the rest of the feedback related to the care provider 106. In some embodiments, a score may be calculated and a new assessment of the care provider 106 will be added to the profile of the care provider 106, which may be used by the care coordinator 104 in selecting care providers.

The system 100 respects the privacy of the patient 102. For example, the care provider 106 does not need to know who the patient is, only the care coordinator 104 and care givers 108 need to know, and the care coordinator 104 does not need to directly know which care givers 108 were involved in the treatment. An identity management component, as will be described below, can be used to assign virtual identities (pseudonyms). The access control policies are distributed, and could be enforced both locally and remotely by the entities with the right data. The system 100 may interface with both physical and online systems, making use of patient feedback for automated care provider selection. The system 100 manages the physical access control in a distributed way, so patients can temporally allow access to the care givers although they do not know the identity of the care giver that will attend to their emergency home care.

For example, an access control policy set by the patient 102 may be: “allow access to the door to Bob, Carol, and to people sent by the care coordinator”. This policy selects particular people to have access to the door (Bob and Carol), and delegates the access decision to the care coordinator 104. The care coordinator 104 may have an access control policy for the patients door and patient information as follows: “permit access if an alert in the patient's house is still active and the care giver has been sent by the care provider.” Thus, the care coordinator 104 does not need to manage the care coordination information of the care givers 108, providing increased privacy. The care provider 106 may have an access policy such as “Alice is attending the emergency xx:yy.” This policy provides access to a particular care giver 108, assuming that the care provider 106 has the ability to provide such access. The care provider 106 generally cannot manage patient information without consent.

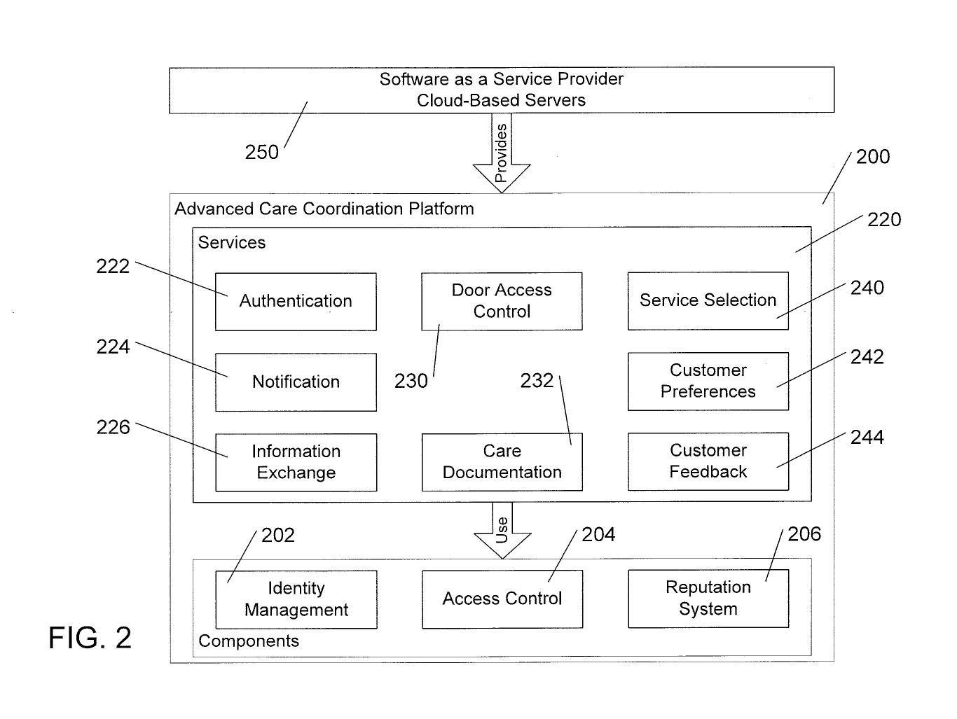

Referring now to FIG. 2, the basic structure of the system is described. The advanced care coordination platform 200 includes three main components—an identity management component 202, an access control component 204, and a reputation system 206. The identity management component 202 supports complex ID brokerage scenarios, cross protocol single sign on, and manages authentication and virtual identities for privacy. The identity management component 202 provides services 220 in the system such as authentication services 222 for users of the system (patients, care coordinators, care providers, care givers), notification services 224 (e.g., directing messages to the proper individuals whose identities have been properly authenticated), and information exchange services 226, such as providing access to distributed electronic health records (EHR).

The access control component 204 provides transparency and confidentiality by supporting hierarchical access requests, and dynamic references to other authoritative domains. Services such as the door access control service 230, which controls physical access to patients' homes, make use of the access control component 204 and the identity management component 202. In some embodiments, similar services (not shown) may use the access control component 204 to access a variety of other physical devices associated with a customer or patient, such as security cameras, sensor readings, control of appliances, heating, lighting, etc., depending on the field in which the system is being used. Other services, such as the care documentation service 232, or other services (not shown) that access patient data, including, e.g., the information exchange services 226 described above, may also make use of the access control component 204 to control access to private data.

In some embodiments, the policies used by the access control component 204 are stored locally by each entity that is part of the system, and may be evaluated locally, but in a hierarchical manner. The policies that are used to control access in the access control component 204 may be evaluated only when needed in some embodiments. Thus, each patient can set his or her own policies for access to physical systems such as his or her door, and can specify who or what class of people may have access. For example, a patient could specify that only particular care providers get access, or that all doctors can have access, or that only specific people get access, or any policy that the patient wishes to establish. These policies (or the results of evaluating these policies as needed) are handled in a hierarchical manner with those of other entities in the system. For example, the policies of the patient may be combined with access policies associated with the care coordinator with which the patient has subscribed, and the care provider that has been selected to provide care to determine what kind of access to data or physical systems will be granted to a particular care giver. In some embodiments, certain policies may be mandatory, such as when access policies are set to comply with local data protection or privacy laws.

The reputation system component 206 supports customized and reputation-based service selection. For example, the reputation system component may manage the reputations of care providers, and update reputation information according to a customer or patient feedback mechanism. Services such as a service selection service 240, which, e.g., assists the care coordinator in selecting a care provider, may use the reputation system component 206. Other services, such as the customer preferences service 242, which permits a customer or patient to provide his or her preferences to the system, and a customer feedback service 244, which obtains feedback information from customers or patients, also use the reputation system component 206.

In some embodiments, further components (not shown) may be included in the advanced care coordination platform 200, such as a components for managing sensors and other components of an ambient assisted living (AAL) system or automated home, and for offering a variety of AAL-related services.

In some embodiments, the components and services described above may be offered through a cloud-based software-as-a-service (SaaS) model. In such a model, the various components and services are offered over the Internet, and may be operated on one or more server computers (e.g., having a processor, memory, storage, etc.) connected to the Internet, and operated by a SaaS provider 250. By using such a SaaS model, the care coordinator and the care providers can run the system with only limited IT infrastructure. Generally, the care coordinator, care givers and patients may need only Web browser access, and in some embodiments may interact with the system over the Web.

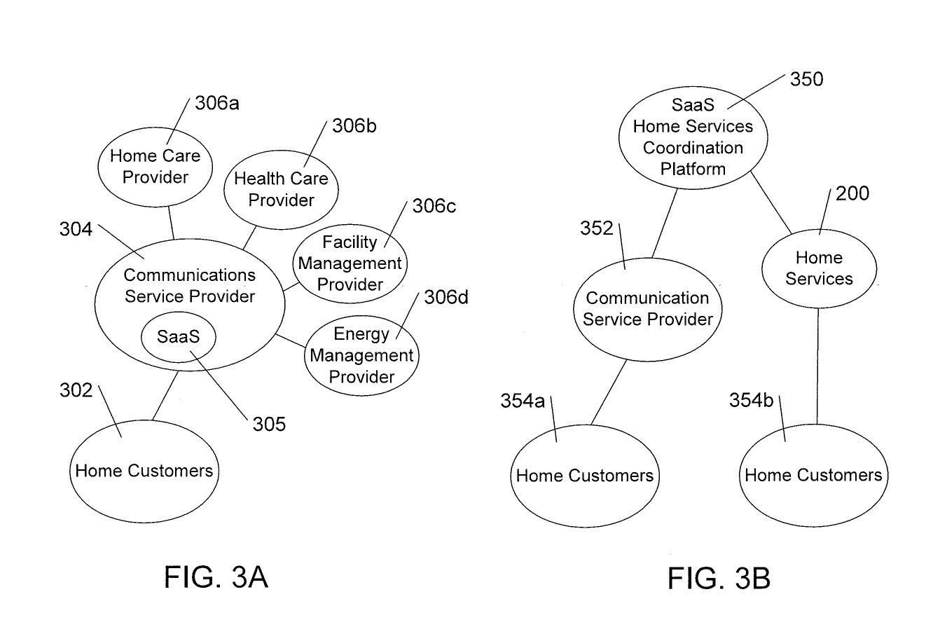

Two alternative setups of the system on a SaaS model are shown in FIGS. 3A and 3B. In FIG. 3A, home customers 302 connect to a communication service provider 304, such as a telephone company, cable company, Internet provider, etc., that includes an advanced home services coordination platform 305 in accordance with embodiments of the invention. Various home service providers 306a-306d, such as home care provider 306a, health care provider 306b, facility management provider 306c and energy management provider 306d are also connected to the communication service provider 304, through which they are connected to and participate in the advanced home services coordination platform 304. The communication service provider operates the home services coordination platform 304, and accepts subscriptions to the platform from the home customers 302 and from the various home service providers 306a-306d, as separate paid subscriptions, or as part of their basic communications subscription or service, or as part of an add-on package subscription or service.

In FIG. 3B, the advanced home services coordination platform 350 operates as a separate service, communicating with, e.g., 3^{rd} parry service providers, such as communication or Internet service providers 352, which are connected to a first set of home customers 354a. The advanced home services coordination platform 350 also communicates with a set of home services 356, which may be directly connected to a second set of home customers 354b. Both the first and second sets of home customers 354a and 354b may take advantage of the services offered through their service providers, which in turn use the advanced home services coordination platform 350 to offer these services. Other service providers (not shown), with their own sets of home subscribers (not shown) could also connect to the cloud-based advanced home services coordination platform 350, to take advantage of its coordination capabilities, as described above, while offering differing sets of services at varying pricing to their home customers.

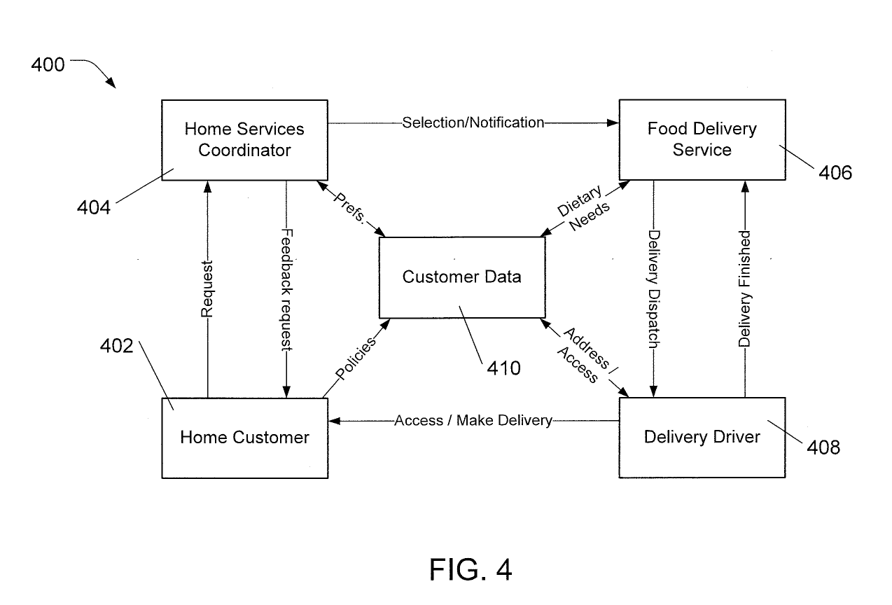

FIG. 4 shows an example of a system 400, in which an advanced home services coordination platform according to various embodiments of the invention is used for a home delivery “meals-on-wheels” service. In this system, which operates in a manner similar to the emergency health-care systems described above, home customers 402 request meal delivery service through a home services coordinator 404. This service request may occur manually, or automatically, e.g., according to a schedule. The home services coordinator 404 then uses data on the personal preferences of the home customer 402 from customer data 410 and the reputation scores of food delivery services 406 to select a food delivery service 406 to handle the order. When it receives the order through the home services coordinator 404, the food delivery service 406 may access preferences, dietary requirements, etc. for the home customer 402. In some embodiments, this may involve accessing sensor data, such as the current blood sugar level of the home customer 402. This information is used by the food delivery service 406 to select a menu that will meet the needs of the home customer 402. The food delivery service 406 then prepares (or otherwise obtains) the food to be sent to the home customer 402, and dispatches a delivery driver 408. The delivery driver 408 is provided with information on the home customer's address, and may be given access to open the door of the home customer 402 in order to deliver the prepared meal. After the meal is delivered, the delivery driver 408 logs this information for auditing and billing purposes. The system also ends any access that the delivery driver 408 may have to the home or door of the home customer 402, and ends access to any data for the completed delivery. Finally, a feedback request is sent to the home customer 402, who may provide feedback on the service and quality that may be used to adjust the home customer's preferences and the reputation scores of the food delivery service 406, which will be used by the home services coordinator 404 in future selection of food delivery services.

While FIG. 4 shows use of a system for a “meals-on-wheels” service, it will be understood that many other possible services could use the same advanced home services platform. As seen above, such a platform could be used to provide healthcare services, such as home care, early patient release, behavior monitoring, and emergency health services. A similar platform could be used to offer a variety of lifestyle services, such as diet and fitness/exercise-related services, facility management services such as home repair or gardening, and other services, such as shopping and home delivery services, energy use monitoring and savings services, security services, and others.

While the invention has been shown and described with reference to specific embodiments, it should be understood that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of coordinating home services comprising:
receiving a request for home services from a customer over a network;
forwarding the request from the customer to a home services coordinator over the network;
using a reputation system to assist the home services coordinator to select a service provider based on customer needs, customer preferences, and a reputation of the service provider;
providing information to the selected service provider over the network sufficient to permit the service provider to select a home delivery provider that can satisfy customer needs;
providing the home delivery provider with access to customer data and with access to a customer physical system over the network; and
requesting feedback from the customer after the service has been delivered, and using the customer feedback in the reputation system to update the customer preferences and the reputation of the service provider.

2. The method of claim 1, wherein providing the home delivery provider with access to customer data and with access to a customer physical system comprises providing the home delivery provider with information on the home address of the customer and with access to unlock an electronic lock to allow entry to the customer's home.

3. The method of claim 1, further comprising receiving information from the home delivery provider, and logging information on the provided service for auditing and billing purposes.

4. The method of claim 1, further comprising limiting data and physical access provided to each of the home services coordinator, the service provider, and the home delivery provider according to access policies.

5. The method of claim 4, wherein the access policies are set by at least one of the customer, the services coordinator, the service provider, and the home delivery provider.

6. The method of claim 1, wherein receiving a request for home services comprises receiving an automated request based on readings from sensors.

7. The method of claim 1, wherein receiving a request for home services comprises receiving an automated request based on a schedule.

8. The method of claim 1, wherein receiving a request for home services comprises receiving a request based on a home emergency call from a home emergency call system or a message from a messaging system.

9. The method of claim 1, further comprising sending notification over the network to the customer of the home delivery provider that will provide the service.

10. The method of claim 9, wherein providing the home delivery provider with access to customer data and with access to a customer physical system comprises providing the home delivery provider with information on the home address of the customer and with access to unlock an electronic lock to allow entry to the customer's home.

11. The method of claim 1, wherein the home services comprise home medical care.

12. The method of claim 11, wherein the service provider comprises a care provider selected from at least one of a medical practice, a hospital, a pharmacy, a nursing care provider, a paramedic service provider, a social care provider, and an emergency medical service provider.

13. The method of claim 11, wherein the home delivery provider comprises a care giver selected from a medical doctor, a nurse, a paramedic, a physiotherapist, and a pharmacist.

14. The method of claim 1, wherein the home services comprise a home food delivery service.

15. The method of claim 14, wherein the service provider comprises a food delivery service, and wherein the home delivery provider comprises a delivery driver.

16. The method of claim 1, wherein the home services comprise at least one of a health care service, a home care service, an in-home nursing service, an early patient release service, a behavior monitoring service, an emergency health service, a lifestyle service, a diet service, a fitness/exercise-related service, a facility management service, a home repair service, a gardening service, a shopping service, a home delivery service, an energy use monitoring and savings service, a catering service, a police service, a fire service, and a security service.

17. A home service coordination platform comprising:
one or more servers connected to a network, including a reputation service component and an access control component, the one or more servers configured to:
receive a request for home services from a customer over the network;
forward the request from the customer to a home services coordinator over the network;
use the reputation system component to assist the home services coordinator to select a service provider based on customer needs, customer preferences, and a reputation of the service provider;
provide information to the selected service provider over the network sufficient to permit the service provider to select a home delivery provider that can satisfy customer needs;
use the access control component to provide the home delivery provider with access to customer data and with access to a customer physical system over the network; and
request feedback from the customer after the service has been delivered, and use the customer feedback in the reputation system component to update the customer preferences and the reputation of the service provider.

18. The home service coordination platform of claim 17, further comprising an identity management component.

19. The home services coordination platform of claim 18, wherein the one or more servers are configured to use the access control component and the identity management component to provide physical access to the home of the customer.

20. The home service coordination platform of claim 17, wherein the one or more servers are configured to use the access control component to provide physical access to the home of the customer.

21. The home service coordination platform of claim 20, wherein the one or more servers are configured to provide physical access to the home of the customer, to open an electronic lock on a door to the home of the customer.
